(19) United States
(12) Patent Application Publication
(10) Pub. No.: US 2014/0047330 A1
(43) Pub. Date: Feb. 13, 2014

(54) COLLABORATIVE DECISION MAKING IN CONTRACT DOCUMENTS

(71) Applicant: Nancy Yan, Cupertino, CA (US)

(72) Inventor: Nancy Yan, Cupertino, CA (US)

(73) Assignee: SAP AG, Waldorf (DE)

(21) Appl. No.: 13/571,282

(22) Filed: Aug. 9, 2012

(51) Int. Cl. G06F 3/048; G06F 17/00; G06F 17/30

(52) U.S. Cl. 715/273; 715/751

(57) ABSTRACT

A method implemented at least in part by a computing device for presenting a contract document for collaborative decision making comprises displaying a contract document, providing an interface adjacent the contract document for initiating a collaborative discussion activity, receiving a designation of at least one clause of the contract for collaboration and at least one recipient to be invited to participate in the collaborative discussion activity, receiving a call for a decision to be made relating to the at least one clause of the contract, sending the call for the decision to the at least one recipient in a communication, and updating a database to store at least the communication, an identity of a sender and the at least one recipient and any discussion or decision received in response to the communication.

### BACKGROUND

In many situations today, it is important to provide multiple people with the opportunity to collaborate on a project, even though physical distance and other impediments might prevent their collaboration in person and in real time. In many scenarios, these individuals are collaborating on a document that is undergoing revisions as it is being tailored to the specific purposes of the project.

As one example, contract documents that govern a company's relationships with others often require input from many different areas of the company both as the contract is initially prepared and, in some cases, during performance of the contract. These multiple areas include different people and different entities, such as different departments or other stakeholder groups. For example, an individual within an organization who is charged with preparing the contract and seeing it through the negotiation stage to execution may need to interact with various departments within the organization. As one specific example, this individual may need to interact with the organization's finance department to ensure that contract terms touching on aspects of financing are appropriate, and then with the legal department to ensure the contract terms are in compliance.

Thus, it would be advantageous to provide an approach to allowing collaborative work on a document such as a contract document by which an individual could maintain control over the process, yet still interact with necessary stakeholders and obtain their input.

### SUMMARY

This Summary is provided to introduce a selection on concepts in a simplified form that are further described below in the Detailed Description.

This Summary is not intended to identify key features or essential features of the claimed subject matter, nor is it intended to be used to limit the scope of the claimed subject matter.

Described below are approaches to presenting a contract document for collaborative work and decision making. According to one implementation, a method is implemented at least in part by one or more computing devices for presenting a contract document for collaborative decision making. The method includes displaying a contract document, providing an interface adjacent the contract document for initiating a collaborative discussion activity, receiving, within the interface, a designation of at least one clause of the contract for collaboration and at least one recipient to be invited to participate in the collaborative discussion activity, receiving, within the interface, a call for a decision to be made relating to the at least one clause of the contract, sending the call for the decision to the at least one recipient in a communication, and updating a database to store at least the communication, an identity of a sender and the at least one recipient and any discussion or decision received in response to the communication.

According to one implementation, a method is implemented at least in part by one or more computing devices for presenting a contract document for collaborative decision making. The method includes receiving a designation of at least one clause of a contract stored in memory, receiving a designation of at least one recipient, initiating a communication within the same display related to the at least one clause of the contract to the at least one recipient, prompting the recipient for a decision related to the at least one clause of the contract and updating a database to store at least the communication.

As another example, a method is described for presenting, on a display, a user interface for collaborative decision making on a contract. The method comprises presenting the contract document such that a user can designate a clause of the contract document. In response to input from the user, a separate discussion panel visible adjacent the contract document is initiated.

The foregoing and other objects, features, and advantages will become more apparent from the following detailed description, which proceeds with reference to the accompanying figures.

### BRIEF DESCRIPTION OF THE DRAWINGS

FIG. 1 is an illustration of an exemplary user interface for collaborating in a contract document.

FIG. 2 is an illustration of another exemplary user interface for collaborating in a contract document.

FIG. 3 is further illustration of the user interface of FIG. 2.

FIG. 4 is a further illustration of the user interface of FIGS. 2 and 3.

FIG. 5 is a further illustration of the user interface of FIGS. 2-4.

FIG. 6 is an illustration of an exemplary user interface showing a discussion activity.

FIG. 7 is a further illustration of the discussion activity of FIG. 6.

FIG. 8 is a further illustration of the discussion activity of FIGS. 6 and 7.

FIG. 9A is a further illustration of the user interface of FIGS. 2-5.

FIG. 9B is a flow chart of an exemplary method.

FIG. 10 is a block diagram of an exemplary computing environment with a collaboration application.

FIG. 11A is an exemplary database schema and object relationship diagram for an exemplary method and apparatus.

FIG. 11B is a flow diagram of an exemplary method for allowing collaboration on different sections of the contract document.

FIG. 12 is a diagram of an exemplary computing system in which some described embodiments can be implemented.

FIG. 13 is an exemplary cloud computing environment that can be used in conjunction with the technologies described herein.

### DETAILED DESCRIPTION

The following description is directed to methods for collaboratively working on documents, in particular, facilitating decision making relating to the documents and underlying projects. For example, one scenario involves a group of people working on a contract document collaboratively, and the need to prompt one or more people to make decisions, e.g., about the content of the contract documents.

The described approaches provide a work environment that facilitates collaboration. Conventionally, ad hoc collaborations are easily initiated among multiple participants and occur via e-mail, chat, telephone, or a combination thereof. Such unstructured collaborations very often fail to leave a “trail” explaining what occurred, and particularly, what decisions were made and for what reasons. Even if communications among the participants might exist, they are likely segregated among one or more participants e-mail inboxes on local computers, and cannot be reliably found or used in the future.

In the current approach, instead of unstructured collaborations, structured collaborations are used to support ad hoc decision making processes, e.g., to improve institutional memory make business more efficient.

The user initiating the collaboration (“initiator”) can be presented with a window or panel that allows for simultaneous viewing of a document and a collaboration or discussion panel. From the discussion panel, the initiator can generate a message to one or more recipients to initiate collaboration. The initiator can specify a topic, and select one or more recipients (co-collaborators or participants). The initiator can type the issue or question in a contents field, or can simply drag and drop one or more clauses (or parts of a document) into the contents field. In this way, quick and nimble communication is facilitated such that the initiator is communicating about only a desired part of the document and only to desired recipients. Short, targeted communications tend to get responded to sooner than others. Each action by each participant is noted and stored in a database. The database can be readily accessed to revisit/analyze who what involved, a chronology of events, what was discussed, and/or what decisions were made, as just some examples. This may be useful when the current contract is revisited or when another contract presents the same issues. The communication trail can be used for analysis and reference.

Preferably, the work environment allows for simultaneous editing of documents, redlining of documents, direct comments, versioning of documents and versioning of document parts. In the case of a contract document, it would be possible to then track that a Version 5 of the contract includes a Version 2 of clause 12, as one example.

Instead of simply initiating communication, the described approaches help the initiator make progress on a project. In the case of a project that is centered on producing a document, such as the contract document example described above, it is usually necessary to obtain input from others and, in many cases, to receive approval or “sign off” before the project can be advanced to the next step or completed. At one level, the described approaches allow the initiator to flag an item for action, e.g., to prompt a recipient for a decision. This can be done in a way that has a distinct visual appearance so that the recipient realizes immediately from the communication that his or her input is required before progress on the project can continue, as opposed to a communication that is received only for monitoring a project and may not require any response.

In many cases, those from whom approval is sought (“approvers”) are making a final judgment on a provisional decision reached by at least one other. At some level, such approvers are attempting to ensure that an adequate process for reaching the decision was followed. The approvers may want to confirm that certain individuals were involved in reaching the provisional decision. In the case of a contract document collaboration, an approver may want to see the revision history for all or a part of the contract document to assess whether an issue was fully “aired out” before the provisional decision was reached. By providing the approver with ready access to prior related discussion items on the same and similar topics and access to the revision history, receiving a prompt and appropriate decision from the approver is facilitated. A user interface that presents the decision being sought together with the document (or an easy link thereto) and the relevant history speeds the process.

In some implementations, the initiator is in fact led or reminded to drive for decisions. That is, the user is guided to frame communications such that necessary input and approvals are sought, rather than simply reporting a status. Collaborators often seek additional information from an initiator to help inform the discussion and make better decisions. In the described approaches, some tools are immediately available for use in discussions and decision making. For example, a user can add a poll to a communication to solicit feedback on an issue, and then readily present the results of the poll, which can assist the group of collaborators in determining next steps. As another example, SWOT (Strengths, Weaknesses/Limitations, Opportunities, Threats) analysis can be communicated among the collaborators and stored for corresponding clauses together with any other communications about the decision making process. In addition, easy to implement Pro/Con tables and What If scenarios can be presented. By providing useful data, metrics and information, collaborators are able to reach better decisions more quickly.

In the case of the contract document example, decisions affecting the language of the contract, once final, cause the contract to be updated with the agreed upon language. Information relating to the decision can be saved. Such information includes the participants, the decision reached, the discussion about the decision and any other alternatives considered, e.g., alternative wordings of a contract clause. In this way, this decision history can be selectively retained and made available for the organization's records for improved institutional memory and use in similar future settings.

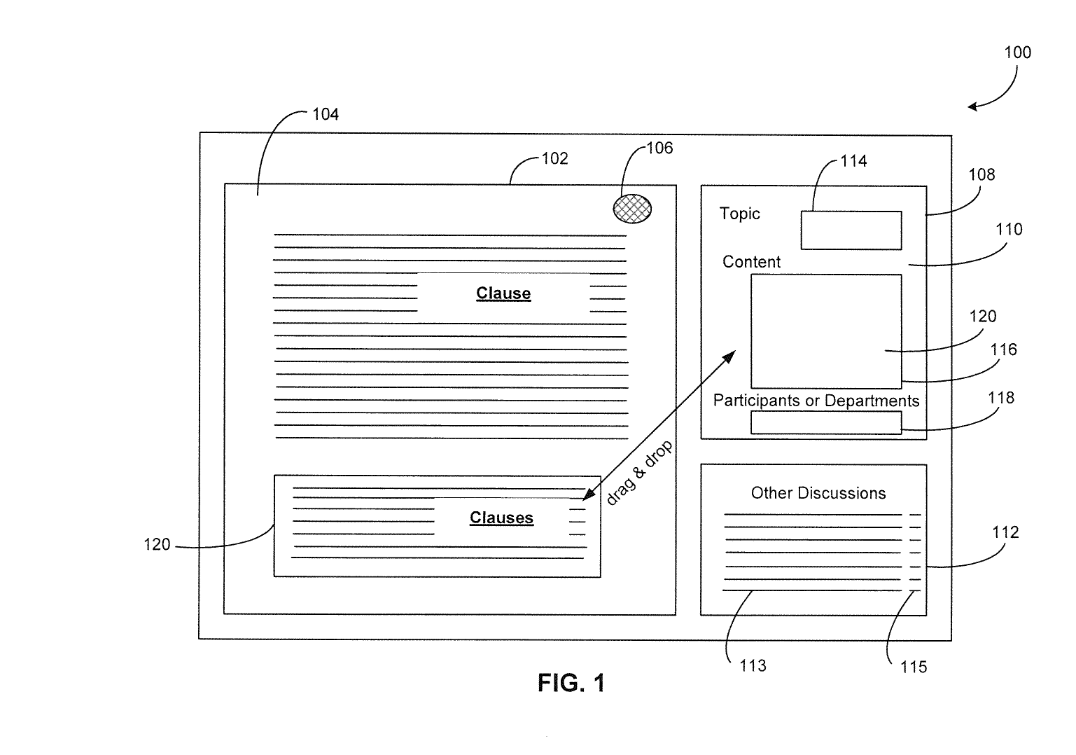

FIG. 1 is an illustration of an exemplary user interface 100 for presenting a contract document for collaborative working. In FIG. 1, there is a document container 102 within which a current contract document 104 is displayed to the user. Among various controls actuatable by the user is a discussion icon or button 106 which the user has just actuated to cause a discussion panel 108 to be displayed. Optionally, an Other Discussions panel 112 may also be displayed. The Other Discussions panel 112 can include links to other discussions related to the current discussion. Optionally, each of the Other Discussions can have a status marker or icon 115, such as “New,” “In Progress,” or “Decision Made,” as just some examples. In addition, the Other Discussions panel 112 can be configured to display other discussions on a user-specific basis, e.g., the contract initiator or project lead can see all other discussions, whereas a participant in the Shipping Department sees only those discussions relating to shipping.

Within the discussion panel 108, there can be a topic field 114 for the user to specify a topic of discussion, as well as a content field 116 for the user to specify the content about which the discussion is concerned. For easy reference, each topic can be automatically prefixed by the system with the contract document name. For convenience, the user interface can enable the user to drag and drop clauses from the contract document 104, such as the clause 120, directly into the content field 116 of the discussion panel 108. The user can then enter names of participants, departments or other organizational entities in a participants field 118 so that the discussion is shared among relevant participants.

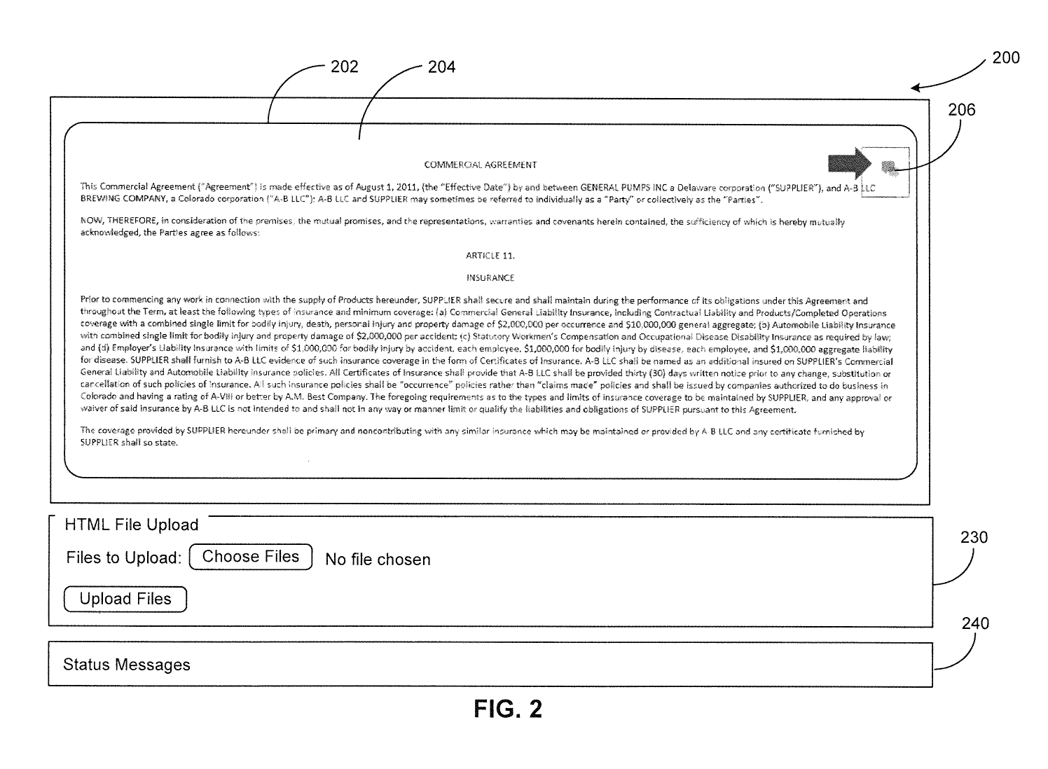

FIG. 2 is an illustration of another exemplary user interface 200 for presenting a contract document for collaborative working. The current contract document 204 is displayed in a documents container 202. A discussion icon or button 206 is available to the user if the user desires to initiate a discussion, such as about the content of the contract document. A file upload panel 230 allows the user to select files for uploading the contract document (or other related documents) from user's local system into the document container 202. A status/messages panel 240 alerts the user if any messages to the user and/or status updates for the system have been received.

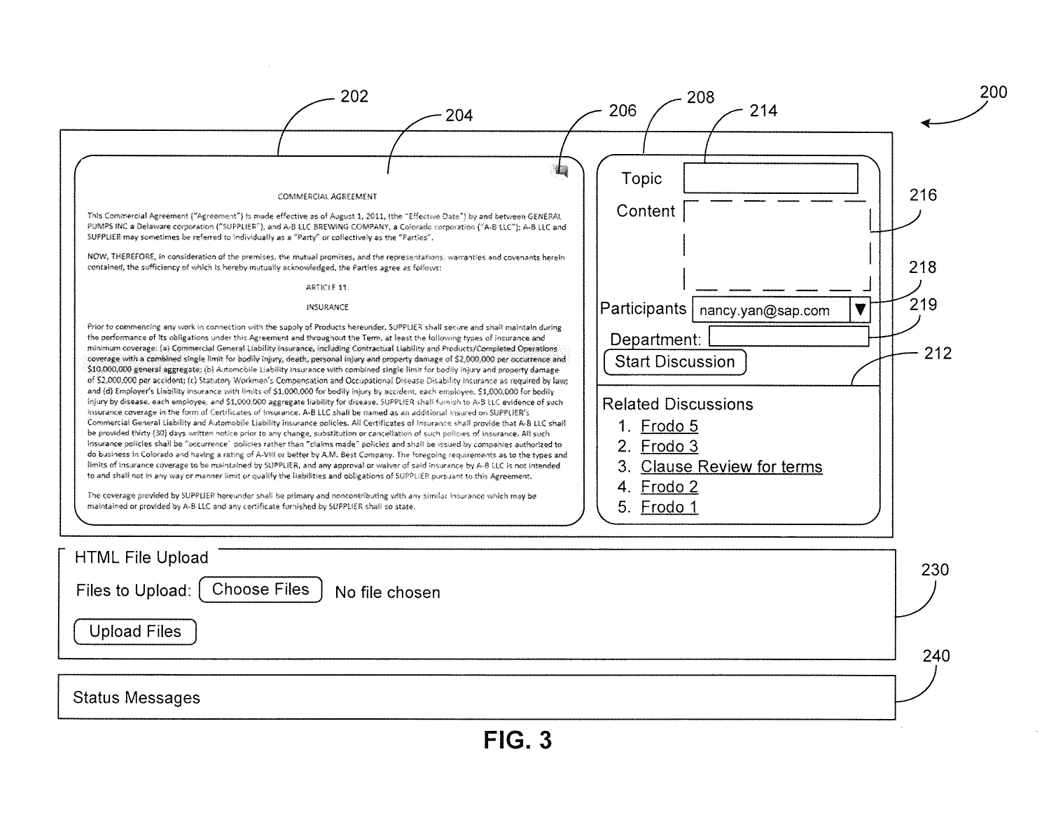

FIG. 3 is an illustration of the user interface 200 after the user has selected the discussion icon or button 206. In response, the user interface 200 has been updated to display a discussion panel 208. In the participants field 218, an identification of the user initiating the discussion, e.g., the e-mail address of the initiating user, can be automatically supplied, and an additional dropdown list of other individuals can be readily accessed. Similarly, a department can be specified in the department field 219. Although in this example the participants field 218 and the department field 219 are separate, it is of course possible to provide these as a single field.

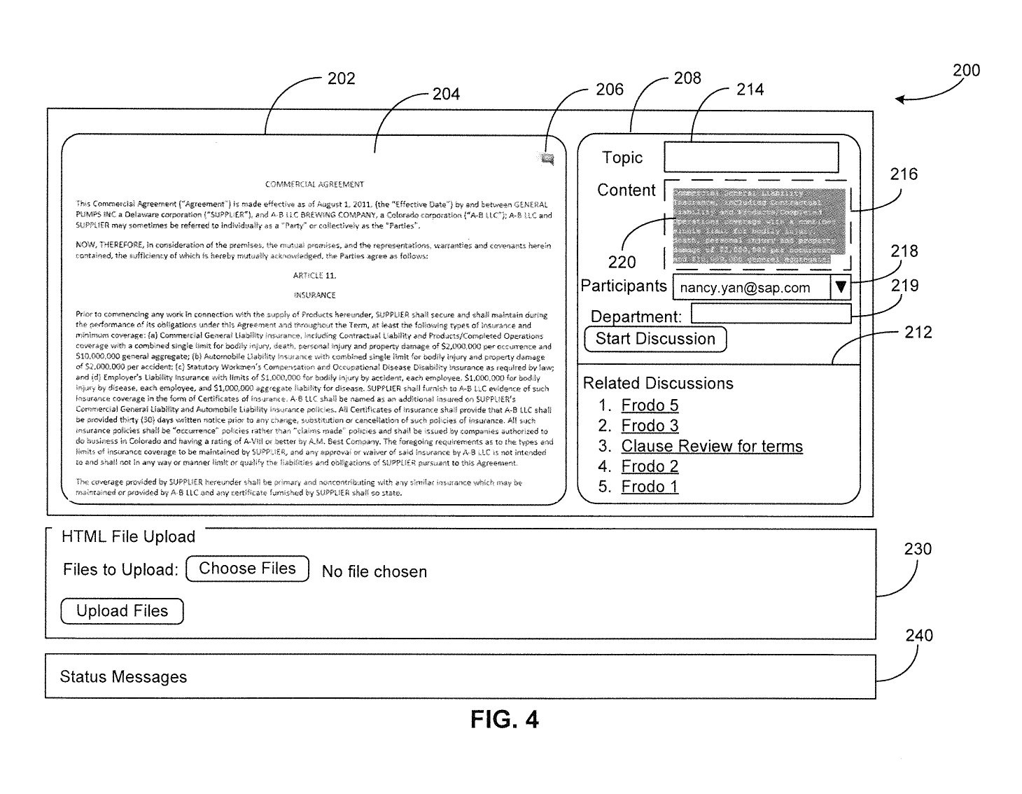

As described above, the user can indicate a topic in the topic field 214 and content in the content field 216. In this example, the user has highlighted a “commercial general liability insurance” clause of the contract document 204 shown in the document container 202. In FIG. 4, the user has specified the commercial general liability insurance clause 220 as the content of the discussion, such as by dragging a copy of the clause 220 from the contract document 204 to the content field 216. The related discussions panel 212 has been populated with five related discussions, which can be based on any number of factors as discussed above.

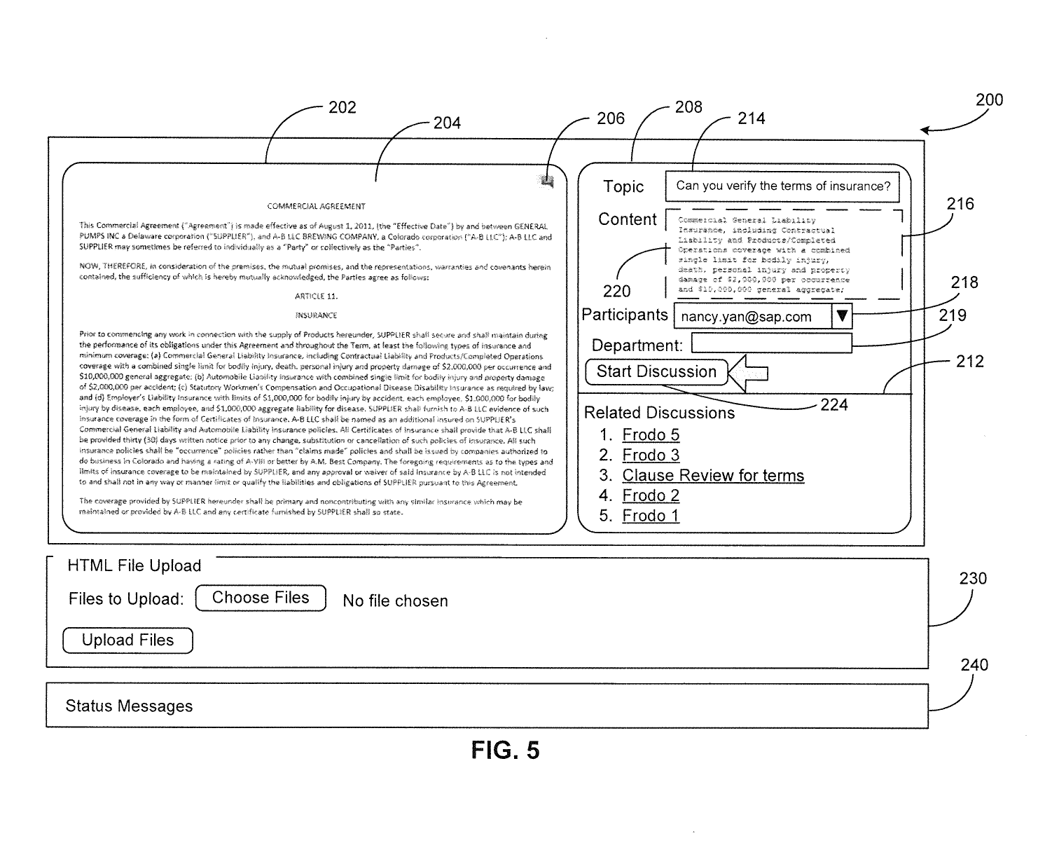

In FIG. 5, the user has entered a topic into the topic field 214 and then actuated a “Start Discussion” button 224. The topic will be automatically prefixed with current document name or contract name.

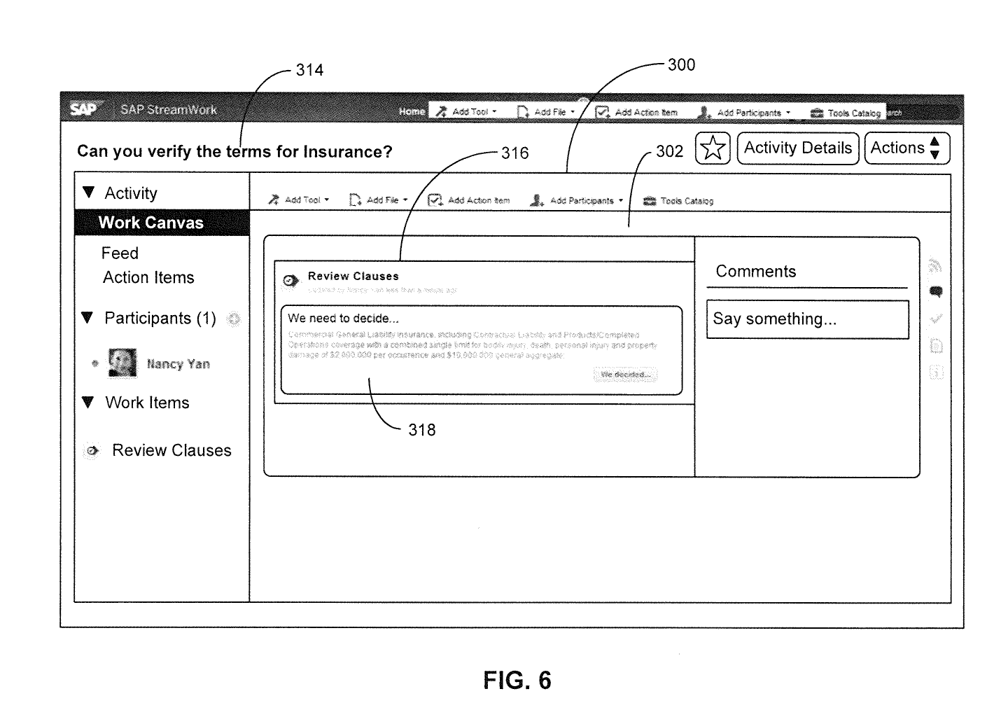

FIG. 6 is an exemplary user interface showing a discussion activity container 300 in which a current discussion activity 302 is displayed. As can be seen in FIG. 6, the discussion activity is entitled with the same topic from the topic field 314 in FIG. 5. The discussion activity 302 includes an action item 316. In this example, the action item is “Review Clauses,” and notes indicate that a user has updated this action item less than a minute ago. A field 318 includes a description of action. In this example, the action is called out as “We need to decide . . . ,” i.e., this is a prompt to at least one other to make or participate in a decision. In some embodiments, users other than the initiator or contract manager (generally, these are the invitees to a discussion activity), may be restricted to viewing only a section or sections of the contract document, such as is shown in FIGS. 6-9. The initiator or contract manager (and others with full rights) have the ability to view the entire contract document in its current state (see, e.g., FIGS. 1-5 and 9A).

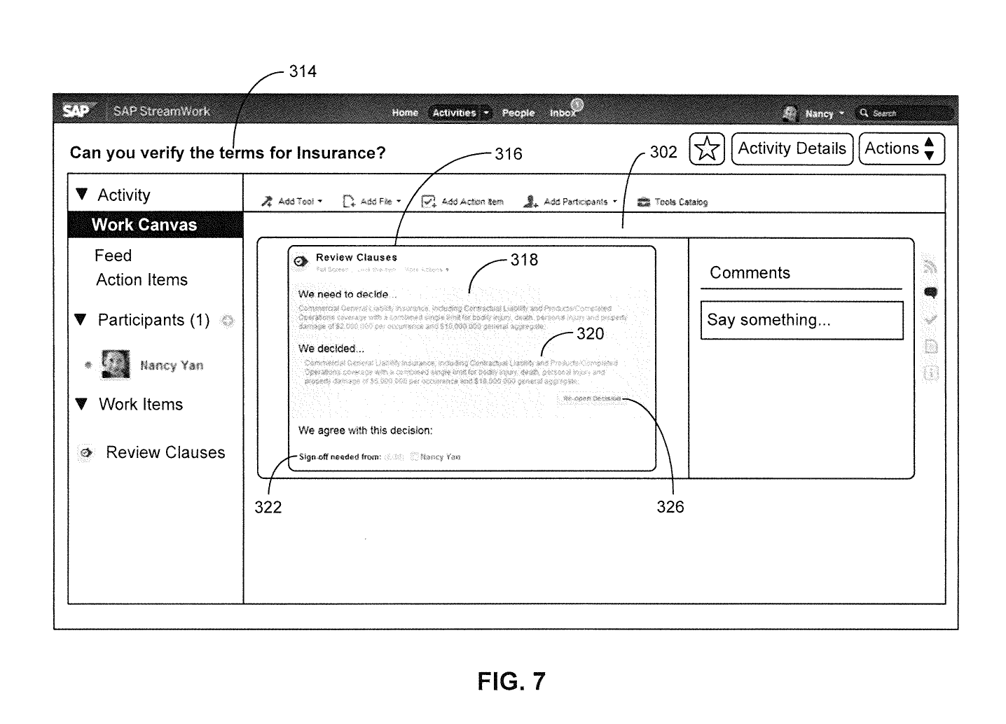

In FIG. 7, the discussion activity 302 has been updated with a field 320 to indicate that an action has been taken. In particular, the field 320 indicates “We decided . . . ,” i.e., a decision was made regarding the language of the Commercial General Liability insurance clause. In particular, it was decided that the combined single limit for bodily injury, death, personal injury and property damage would be set to “$5,000,000 per occurrence and $10,000,000 general aggregate.” The update to the action item may reflect that the user and other participants have exchanged opinions within the discussion activity container 300 by using commenting, real-time chat, pros and cons, and other analysis tools and then reached the decision indicated. An approval field 322 is displayed to indicate which person(s) and/or entities must approve the decision (also called a provisional decision) that was reached. In addition, there is a re-open decision button 326 that is displayed so that a user or perhaps a predetermined class of users can indicate that the decision needs to be reopened.

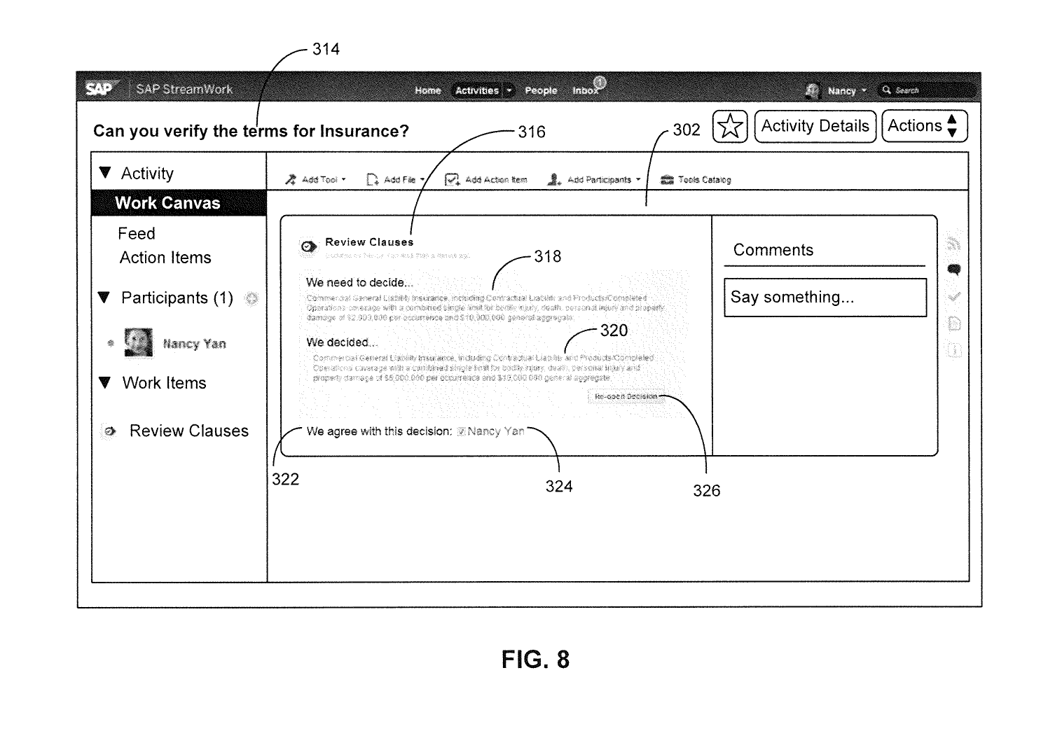

In FIG. 8, an approval indicator 324 has been added to indicate that the specified user has indicated agreement with the decision reached. In some implementations, the contract document would then be automatically updated to reflect the agreed upon language.

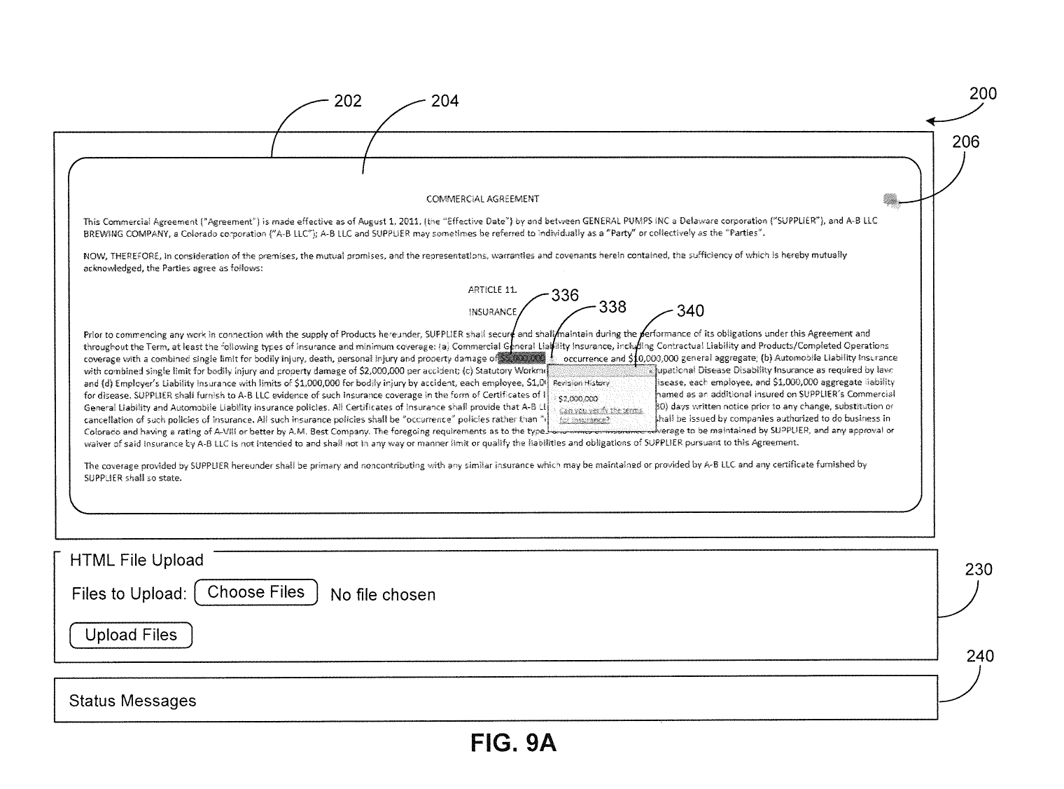

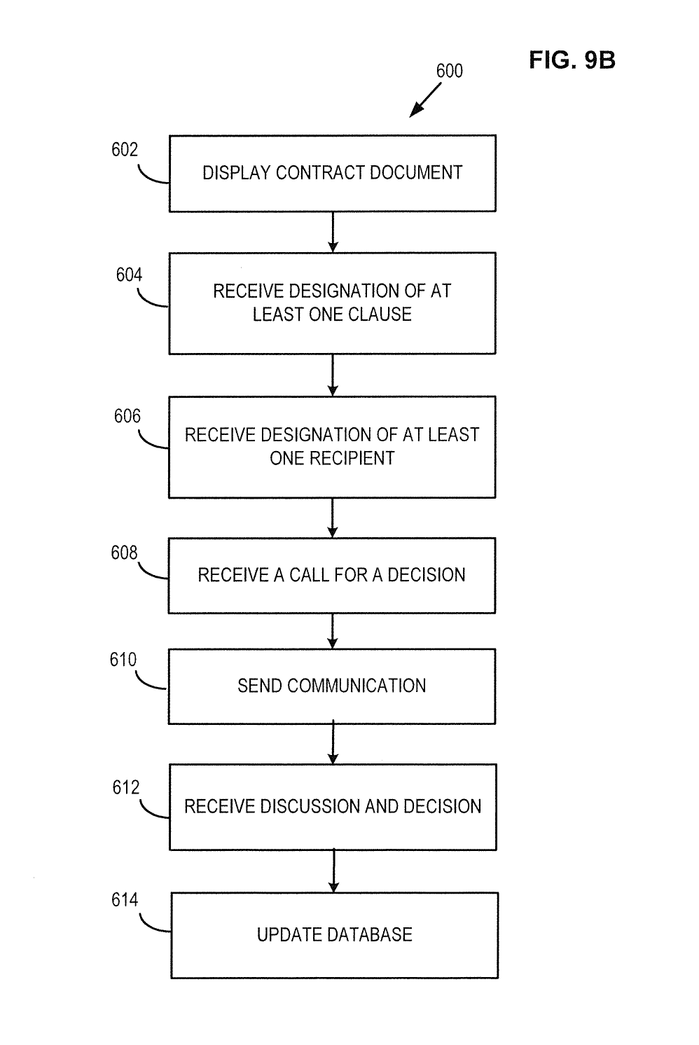

FIG. 9A is another view of the user interface 200 showing the document container 202 and the current document 204, together with a highlighted term 336. The highlighted term is the single limit for bodily injury, death, personal injury and property damage of $5,000,000. As shown, a revision history button 338 can be displayed, such as by hovering a mouse pointer over the button 338, to display the revision history of this clause and the associated discussion item in a revision history panel 340. In this way, a user reviewing the contract can quickly access the history of a particular clause to learn how it was agreed upon, such as what issues were addressed and who participated in making decisions about the clause.

Thus, according to the examples described herein, one illustrative method implementation can be described in connection with the flow diagram of FIG. 9B. In a method 600, a contract document is displayed to a user on a screen of a computing device (step 602). In step 604, a collaborative discussion activity is initiated and the designation of at least one clause is received from the user. For example, the user may highlight, drag and drop the clause, as described above, or the user may specify the clause in another suitable way. In step 606, the designation of at least one recipient is received. For example, the user can address the recipient by name or by function. In step 608, the user is guided by the interface to call for a decision, i.e., to ask the recipient specifically to decide on an open issue. In step 610, a communication calling for a decision is sent to the recipient. In step 612, the recipient responds, such as by specifying a decision and/or providing discussion, and this response is received by the user. In step 614, the database is updated to track the history of the collaborative discussion activity, and at least the communication and any response or decision is saved. In this way, the ability to track what was discussed in reaching a decision on a particular clause of a contract can be tracked.

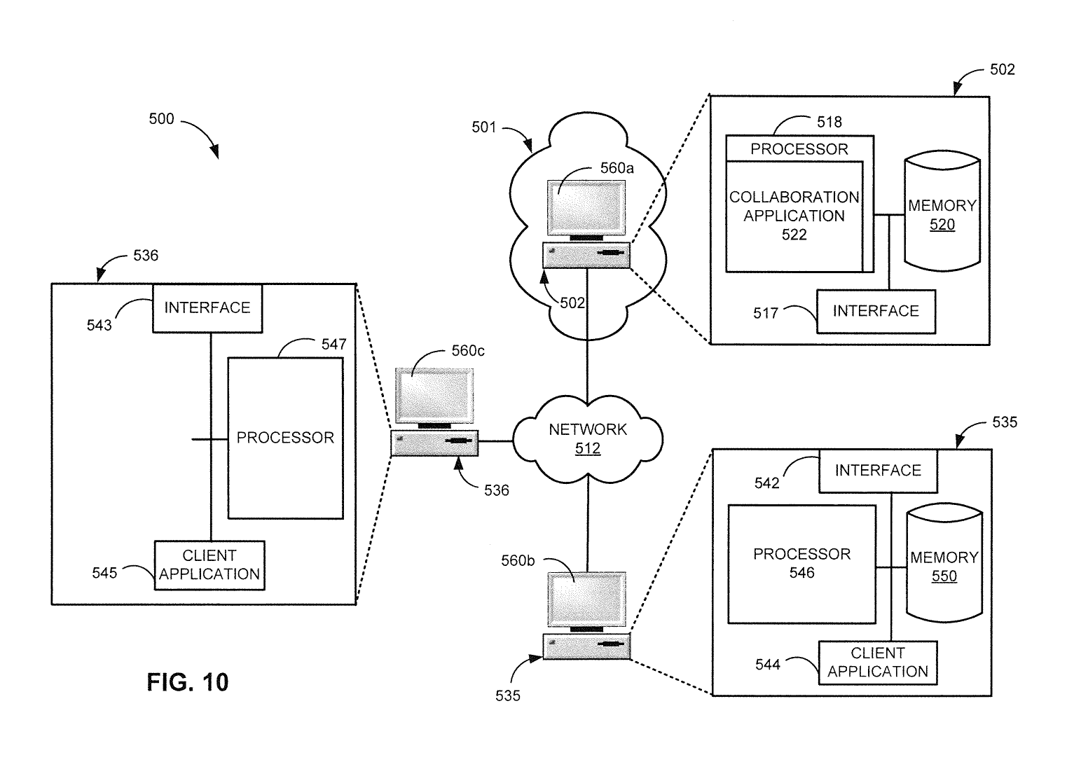

FIG. 10 illustrates an example environment 500 for monitoring entries in a collaboration and implementing one or more business process(es) of at least one business process model based on the entries. The illustrated environment 500 includes or is communicably coupled with server 502 and one or more clients 535 and 536, at least some of which communicate across network 512. In general, environment 500 depicts an example configuration of a system capable of providing access to online collaboration tools. The environment 500 also supports one or more servers operable to provide a set of services to the client 535 or server 502 in which the one or more servers can be logically grouped and accessible within a cloud computing network. For example, server 502 is a cloud-based server, persisting in cloud 501. Accordingly, the collaboration interface may be provided to a client 535 or server 502 as an on-demand solution through the cloud computing network or as a traditional server-client system. Further, the environment 500 also supports a BPMS system operated by one or more web application servers. Different components of the BPMS system may be used to in a collaboration based on participant entries or requests.

In general, server 502 is any server that stores one or more hosted applications, such as collaboration application 522, where at least a portion of the hosted applications are executed via requests and responses sent to users (also referred to as participants) or clients within and communicably coupled to the illustrated environment 500 of FIG. 10. As just some examples, server 502 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, the server 502 may store a plurality of various hosted applications, while in other instances, the server 502 may be a dedicated server meant to store and execute only a single hosted application. In FIG. 10, the collaboration application 522 provides a collaboration interface for users to participate in collaborations. In some instances, the server 502 may comprise a web server or be communicably coupled with a web server, where the collaboration applications 522 represent one or more web-based applications accessed and executed via network 512 by the clients 535 and 536 of the system 500 to perform the programmed tasks or operations of the collaboration application 522.

At a high level, the server 502 includes an electronic computing device, such as processor 518, operable to receive, transmit, process, store, or manage data and information associated with the environment 500. The server 502 illustrated in FIG. 10 can be responsible for receiving application requests from one or more client applications 544 or 545 or business applications associated with the clients 535 and 536 of environment 500 and responding to the received requests by processing them in the associated collaboration application 522, and sending the appropriate response from the collaboration application 522 back to the requesting client application 544 or 545. Alternatively, the collaboration application 522 at server 502 can be capable of processing and responding to local requests from a user accessing server 502 locally. Accordingly, in addition to requests from the external clients 535 and 536 illustrated in FIG. 10, requests associated with the collaboration applications 522 may also be sent from internal users, external or third-party customers, other automated applications, as well as any other appropriate entities, individuals, systems, or computers. Further, the terms “client application” and “business application” may be used interchangeably as appropriate without departing from the scope of this disclosure.

As used in the present disclosure, the term “computer” is intended to encompass any suitable processing unit. For example, although FIG. 10 illustrates a single server 502, environment 500 can be implemented using two or more servers 502, as well as computers other than servers, including a server pool. Indeed, server 502 may be any computer or processing unit such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 502 may be adapted to execute any operating system, including Linux, UNIX, Windows, Mac OS, or any other suitable operating system. According to one embodiment, server 502 may also include or be communicably coupled with a mail server.

In the illustrated implementation, and as shown in FIG. 10, the server 502 includes a processor 518, an interface 517, a memory 520, and a collaboration application 522. The interface 517 is used by the server 502 for communicating with other systems in a client-server or other distributed environment (including within environment 500) connected to the network 512 (e.g., clients 535 and 536, as well as other systems communicably coupled to the network 512). Although FIG. 10 depicts a server-client environment, other implementations of the runtime framework for providing business processes within a collaboration are within the scope of the present disclosure. For example, the runtime framework may be provided or accessed locally at a computer. Generally, the interface 517 includes logic encoded in software and/or hardware in a suitable combination and operable to communicate with the network 512. More specifically, the interface 517 may include software supporting one or more communication protocols associated with communications such that the network 512 or interface's hardware is operable to communicate physical signals within and outside of the illustrated environment 500.

In some implementations, the server 502 may also include a user interface, such as a graphical user interface (GUI) 560a (560b for client 536 and 560c for client 536). The interfaces described above in connection with FIG. 1 (i.e., the interface 100), FIGS. 2-5 and 9 (i.e., the interface 200) and FIGS. 6-8 are examples.

The GUI 560a can comprise a graphical user interface operable to, for example, allow the user of the server 502 to interface with at least a portion of the platform for any suitable purpose, such as, e.g., creating, preparing, requesting, or analyzing data, as well as viewing and accessing source documents. Generally, the GUI 560a provides the particular user with an efficient and user-friendly presentation of data provided by or communicated within the system.

The GUI 560a may comprise a plurality of customizable frames or views having interactive fields, pull-down lists, buttons, and other controls operated by the user. For example, GUI 560a may provide interactive elements that allow a user to enter or select elements of business process instances in GUI 560a. More generally, GUI 560a may also provide general interactive elements that allow a user to access and utilize various services and functions of application 522. The GUI 560a is often configurable, supports a combination of tables and graphs (bar, line, pie, status dials, etc.), and is able to build real-time portals, where tabs are delineated by key characteristics (e.g. site or micro-site). Therefore, the GUI 560a contemplates any suitable graphical user interface, such as a combination of a generic web browser, intelligent engine, and command line interface (CLI) that processes information in the platform and efficiently presents the results to the user visually. Similar reference numerals correspond to similar elements of FIG. 10. For example, GUI 560b and 560c are similar to GUI 560a.

Generally, example server 502 may be communicably coupled with a network 512 that facilitates wireless or wireline communications between the components of the environment 500 (e.g., between the server 502 and client 535), as well as with any other local or remote computer, such as additional clients, servers, or other devices communicably coupled to network 512 but not illustrated in FIG. 10. In the illustrated environment, the network 512 is depicted as a single network in FIG. 10, but may be comprised of more than one network without departing from the scope of this disclosure, so long as at least a portion of the network 512 may facilitate communications between senders and recipients. The network 512 may be all or a portion of an enterprise or secured network, while in another instance at least a portion of the network 512 may represent a connection to the Internet. In some instances, a portion of the network 512 may be a virtual private network (VPN), such as, for example, the connection between the client 535 and the server 502. Further, all or a portion of the network 512 can comprise either a wireline or wireless link. Example wireless links may include 802.11a/b/g/n, 802.20, WiMax, and/or any other appropriate wireless link. In other words, the network 512 encompasses any internal or external network, networks, sub-network, or combination thereof operable to facilitate communications between various computing components inside and outside the illustrated environment 500. The network 512 may communicate, for example, Internet Protocol (IP) packets, Frame Relay frames, Asynchronous Transfer Mode (ATM) cells, voice, video, data, and other suitable information between network addresses. The network 512 may also include one or more local area networks (LANs), radio access networks (RANs), metropolitan area networks (MANs), wide area networks (WANs), all or a portion of the Internet, and/or any other communication system or systems at one or more locations. The network 512, however, is not a required component of the present disclosure.

As illustrated in FIG. 10, server 502 includes a processor 518. Although illustrated as a single processor 518 in FIG. 10, two or more processors may be used according to particular needs, desires, or particular embodiments of environment 500. Each processor 518 may be a central processing unit (CPU), a blade, an application specific integrated circuit (ASIC), a field-programmable gate array (FPGA), or another suitable component. Generally, the processor 518 executes instructions and manipulates data to perform the operations of server 502 and, specifically, the one or more plurality of collaboration applications 522. Specifically, the server's processor 518 executes the functionality required to receive and respond to requests from the clients 535 and their respective client applications 544, as well as the functionality required to perform the other operations of the collaboration application 522.

Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 10 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate. In the illustrated environment 500, processor 518 executes one or more collaboration applications 522 on the server 502.

At a high level, each of the one or more collaboration applications 522 is any application, program, module, process, or other software that may execute, change, delete, generate, or otherwise manage information according to the present disclosure, particularly in response to and in connection with one or more requests received from the illustrated clients 535 and their associated client applications 544. In certain cases, only one collaboration application 522 may be located at a particular server 502. In others, a plurality of related and/or unrelated collaboration applications 522 may be stored at a single server 502, or located across a plurality of other servers 502, as well. Additionally, the collaboration applications 522 may represent web-based applications accessed and executed by remote clients 535 or client applications 544 via the network 512 (e.g., through the Internet). Further, while illustrated as internal to server 502, one or more processes associated with a particular collaboration application 522 may be stored, referenced, or executed remotely. For example, a portion of a particular collaboration application 522 may be a web service associated with the application that is remotely called, while another portion of the collaboration application 522 may be an interface object or agent bundled for processing at a remote client 535 or 536. Moreover, any or all of the collaboration applications 522 may be a child or sub-module of another software module or enterprise application (not illustrated) without departing from the scope of this disclosure. Still further, portions of the collaboration application 522 may be executed by a user working directly at server 502, as well as remotely at client 535 or 536. As mentioned previously, server 502 may host collaboration applications 522 in a cloud based environment.

As illustrated, processor 518 can also execute a collaboration (via the collaboration application 522) that provides an environment and user interface for engaging in online collaborations involving at least one participant. The collaboration may also include other participants. In some implementations, the collaboration can be executed by a different processor or server external to server 502, such as by a server communicably coupled to server 502 through network 512. For example, the collaboration may be provided as an on-demand service through a cloud computing network, as a web service accessible via network 512, or as a service provided on a dedicated server. The collaboration can provide interfaces, modules, services, or metadata definitions that enable client applications 544 or 545 to provide support for implementing a business process executed at server 502 or at a different server or workstation. In the present disclosure, a business process may be any collection of related activities, tasks, or sequential steps performed in association with a particular business context, business partner, or customer. Business processes may be performed in software as a computer program and/or in connection with a computer microprocessor, server, workstation, instance of a computer program, thread of execution within a computer program, or other data processing element. Each business process may be associated with a workflow, and each distinct case or occurrence of the workflow or a portion of the workflow may be a separate process instance of a particular business process. Business processes are described in more detail below.

In the illustrated example, the server 502 may provide a collaboration application 522 for presenting graphical tools to clients for participating in collaborations and for interacting with gadgets or widgets associated with a business process. In general, the server 502 also includes memory 520 for storing data and program instructions. Memory 520 may include any memory or database module and may take the form of volatile or non-volatile memory including, without limitation, magnetic media, optical media, random access memory (RAM), read-only memory (ROM), removable media, or any other suitable local or remote memory component. Memory 520 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 502 and its one or more collaboration applications 522. In some implementations, collaboration application 522 is available to a client, such as client 535, through a web browser-based application at client 535. In some instances, collaboration application 522 persists in a cloud based network. Example collaboration applications include SAP Streamwork, Jam, Google Wave, TextFlow™, Google Groups, MindMeister, and Zoho™. The collaboration may be a synchronous collaboration, such as collaborations undertaken using a chat program or other synchronous collaboration tools. The collaboration may be asynchronous, and the participants may use e-mail programs to conduct the collaboration.

The illustrated environment of FIG. 10 also includes one or more clients 535. Each client 535 may be any computing device operable to connect to or communicate with at least the server 502 and/or via the network 512 using a wireline or wireless connection. In addition, client 535 may persist in a cloud based network. Further, as illustrated in FIG. 10, client 535 includes a processor 546, an interface 542, a graphical user interface (GUI) 560b, a client application 544, and a memory 550. In general, client 535 comprises an electronic computer device operable to receive, transmit, process, and store any appropriate data associated with the environment 500 of FIG. 10. It will be understood that there may be any number of clients 535 associated with, or external to, environment 500. For example, while illustrated environment 500 includes one client 535, alternative implementations of environment 500 may include multiple clients communicably coupled to the server 502, or any other number of clients suitable to the purposes of the environment 500. Additionally, there may also be one or more additional clients 535 external to the illustrated portion of environment 500 that are capable of interacting with the environment 500 via the network 512. Further, the terms “client,” “user,” and “participant” may be used interchangeably as appropriate without departing from the scope of this disclosure. Moreover, while each client 535 is described in terms of being used by a single user, this disclosure contemplates that many users may use one computer, or that one user may use multiple computers. Client application 544 may be a web browser or other application used to access, join, and/or participate in a collaboration on collaboration application 522 hosted on server 502.

The collaboration application facilitates decision making: it prompts one or more users for decisions, it receives decisions made by one or more users, it reports final decisions, it seeks approval of provisional decisions, its allows for decisions to be reopened as necessary, etc.

In some embodiments, the CCC is implemented as a reuse component. That is, the CCC can be configured as a module or plug-in or component that can be implemented as part of an application without additional coding or programming. For example, a reuse CCC may need to be configured for a particular application. However, a developer's skills may not be necessary for implementation. In this matter, the CCC functionality can be easily reused in different applications.

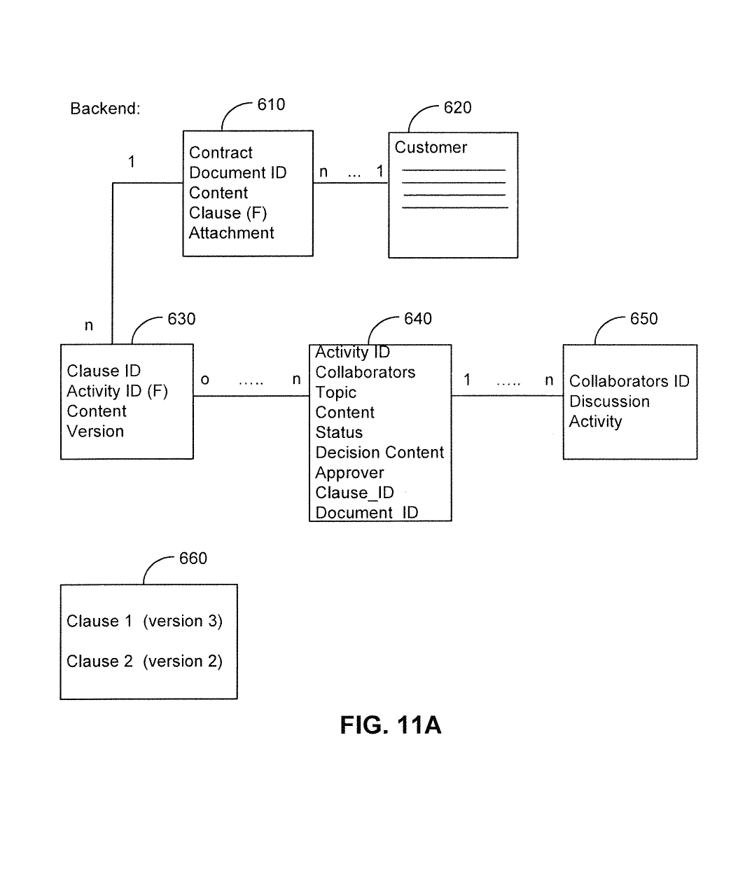

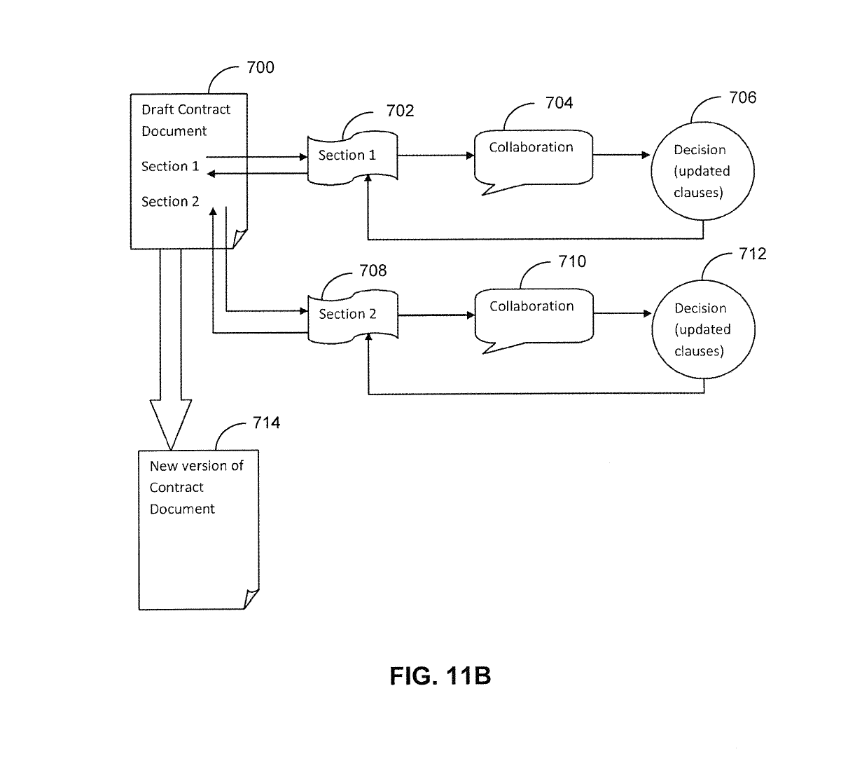

FIG. 11A is a database schema and object relationship diagram illustrating an exemplary implementation of a suitable database for carrying out the described methods. For each customer 620, there is a one-to-many relationship with 1-n contract documents 610 for that customer. Each contract document 610 is identified by an ID number. For each contract document 610, there is a one-to-many relationship with 1-n clauses 630 of the contract. Each clause 630 is identified with a clause ID numbers and, as appropriate, an activity ID number. A version of the clause is also recorded. For each clause on which an activity is generated, there is an activity 640. Each activity 640 includes the activity ID number, the collaborators, the topic, the content, a status field, a decision content field, and approver field, a clause_id and a document_id. For each activity, there is a one-to-many relationship with multiple collaborators 650. Each collaborator 650 has a collaborator ID and is associated with one or more discussion activities. The prior versions of clauses 660 that have been reviewed and modified are also saved as new instances of clause object 630. Each version of clause could have many activities associated therewith.

All activities relating to clauses can be “rolled up” from clause to document level. So, contract managers can get an overview of collaboration points in the document. All activities initiated from the current contract document are visible in the All Activities panel if the user has sufficient permission, such as an initiator or contract manager.

In some embodiments, only an initiator or contract manager has access to view the entire contract document. In these embodiments, it may be helpful to provide for simultaneous parallel collaboration of different contract document sections by different users and/or departments.

For example, as shown in FIG. 11B, a contract document 700 may have a first section 702 that is subject to a first collaboration 704 with a first entity (such as a user). Within the collaboration environment as described above, the initiator and the user work through the issue(s) arising from the first section until a decision(s) 706 is reached. Thereafter, the first section 702 of the contract document 700 is updated with the resulting changes, and the system is updated to make a record of the decision.

Meanwhile, it is possible for the initiator to start a second collaboration 710 that overlaps in time with the first collaboration 704. The second collaboration 710 can be on the topic of a second section 708 of the contract document 700. The second collaboration 710 can be carried with the same participants, or, more likely, with different participants. In the example of FIG. 11B, the second collaboration is carried out with a department (e.g., the Shipping department) rather than an individual. The initiator and the department work through the issues relating to the second section 708. After the second collaboration 710 is concluded, any decision(s) 712 reached is recorded, any change(s) to the second section 708 is made, and the contract document 700 is revised accordingly. Thereafter, a revised or new version 714 of the contract document in which both the first section 702 and the second section 708 have been revised becomes available.

In some cases, the initiator may not be directly involved in the collaboration, but may instead oversee collaboration between other individuals and/or entities that make a decision regarding the content of a contract document section.

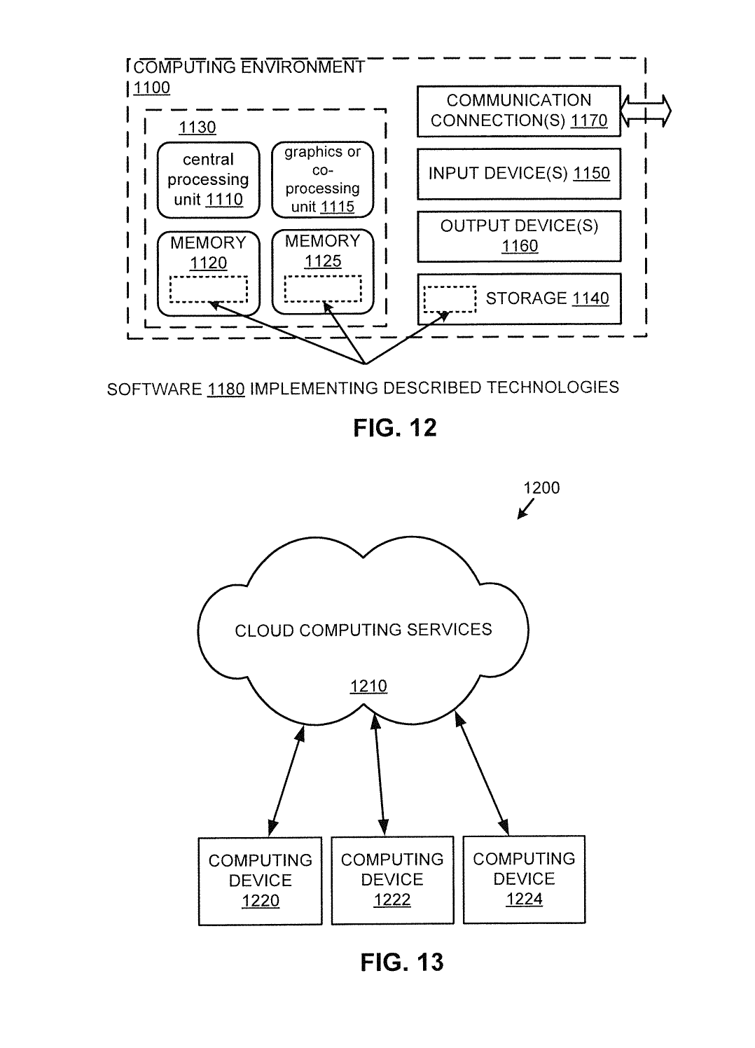

FIG. 12 depicts a generalized example for a suitable computing system 1100 in which the described innovations may be implemented. The computing system 1100 is not intended to suggest any limitation as to scope of use or functionality, as the innovations may be implemented in diverse general-purpose or special-purpose computing systems.

With reference to FIG. 12, the computing system 1100 includes one or more processing units 1110, 1115 and memory 1120, 1125. In FIG. 12, this basic configuration 1130 is included within a dashed line. The processing units 1110, 1115 execute computer-executable instructions. A processing unit can be a general-purpose central processing unit (CPU), processor in an application-specific integrated circuit (ASIC) or any other type of processor. In a multiprocessing system, multiple processing units execute computer-executable instructions to increase processing power. For example, FIG. 12 shows a central processing unit 1110 as well as a graphic processing unit or co-processing unit 1115. The tangible memory 1120, 1125 may be volatile memory (e.g., registers, cashes, RAM), non-volatile memory (e.g., ROM, EEPROM, flash memory), or some combination of the two, accessible by the processing unit(s). The memory 1120, 1125 stores software 1180 implementing one or more innovations described herein, in the form of computer-executable instructions suitable for execution by the processing unit(s).

A computing system may have additional features. For example, the computing system 1100 includes storage 1140, one or more input devices 1150, one or more output devices 1160, and one or more communication connections 1170. An interconnection mechanism (not shown) such as a bus, controller, or network interconnects the components of the computing system 1100. Typically, operating system software (not shown) provides an operating environment for other software executing in the computing system 1100 and coordinates activities of the components of the computing system 1100.

The tangible storage 1140 may be removable or non-removable, and incudes magnetic disks, magnetic tapes or cassettes, CD-ROMs, DVDs or any other medium which can be used to store information in a non-transitory way and which can be accessed within the computing system 1100. The storage 1140 stores instructions for the software 1180 implementing one or more innovations described herein. The input device(s) 1150 may be a touch input device such as a keyboard, mouse, pen or trackball, a voice input device, a scanning device, or another device that provides input to the computing system 1100. For video encoding, the input device(s) 1150 may be a camera, video card, TV tuner card, or other similar device that accepts video input in analog or digital form, or a CD-ROM or CD-RW that reads video samples into the computing system 1100. The output device(s) 1160 may be a display, printer, speaker, CD-writer, or another device that provides output from the computing system 1100.

The communication connection(s) 1170 enable communication over a communication medium to another computing entity. The communication medium conveys information such as computer-executable instructions, audio or video input or output, or other data in a modulated data signal. A modulated data signal is a signal that has one or more of its characteristics set or changed in such a matter as to encode information in the signal. By way of example, and not limitation, communication media can use an electrical, optical, RF or other carrier.

The innovations can be described in the general context of computer-executable instructions, such as those included in program modules, being executed in a computing system on a target reel or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can local or distributed, and can include any combination of special-purpose hardware and/or general-purpose hardware with software implementing the functionality described herein.

For the sake of presentation, the detailed description uses terms like “determine” and “use” to describe computer operations in a computing system. The terms are high-level abstractions for operations being performed by a computer, and should not be confused with acts performed by a human being. The actual computer operations corresponding to these terms vary depending upon implementation.

FIG. 13 depicts an example cloud computing environment 1200 in which the described technologies can be implemented. The cloud computing environment 1200 comprises cloud computing services 1210. The cloud computing services 1210 can comprise various types of cloud computing resources, such as computer servers, data storage repositories, networking resources, etc. The cloud computing serves 1210 can be centrally located (e.g., provided by a data center of a business or organization) or distributed (e.g., provided by various computing resources located at different locations, such as different data centers and/or located in different cities or countries).

The cloud computing services 1210 are utilized by various types of computing devices (e.g., client computing devices), such as computing devices 1220, 1222 and 1224. For example, the computing devices can be computers (e.g., desktop or laptop computers), mobile devices (e.g., tablet computers or smart phones), or other types of computing devices. For example, the computing devices (e.g., 1220, 1222 and 1224) can utilize the cloud computing serves 1210 to perform computing operations (e.g., data processing, data storage and the like).

Referring to FIG. 10, one or more of the user interface layer 510, the CCC 520, 530, the data access layer 540, and the data store 550 can be implemented as part of the cloud computing services. Likewise, one or more of the user interface layer 510, the CCC 520, 530, the data access layer 540, and the data store 550 can be implemented as one or more of the computing services 1220, 1222, 1224.

Although the operations of some of the disclosed methods are described in a particular, sequential order or convenient presentations, it should be understood that this manner of description encompasses rearrangement, unless a particular ordering is required by specific language set forth below. For example, operations described sequentially may in some cases may be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smartphones or other mobile devices that include computing hardware). Computer readable storage media are any available tangible media that can be accessed within a computing environment (e.g., non-transitory computer-readable media, such as one or more optical media disks such as DVD or CD disks, volatile memory components (such as DRAM or SHRAM), or non-volatile memory components (such as flash memory or hard drives)). By way of example and with reference to FIG. 12, computer-readable storage media include memory 1120 and 1125 and storage 1140. As should be readily understood, the term “computer-readable storage media” does not include communication connections (e.g., 1170) such as modulated data signals.

Any of the computer-executable instructions for implementing the disclosed techniques as well as any data created and used in implementation of the disclosed embodiments can be stored on one or more computer-readable storage media (e.g., non-transitory computer-readable media). The computer-executable instructions can be part of, for example, a dedicated software application or a software application that is accessed or downloaded via web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For example, the disclosed technology can be implemented by software written in C++, Java, Perl, Java Script, HTML5, ABAP, Adobe Flash, or any other suitable programming language. The working environment described herein can be implemented in SAP Streamwork, Jam, or other suitable collaboration software platform.

Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or merely accessed through a suitable communication means. Such suitable communication means include, for example, the Internet, the Worldwide Web, an intranet software applications, cable (including fiber optic cable), magnetic communications, electromagnetic communications (including RF, microwave, and infrared communications), electronic communications, or other communication means.

The disclosed methods, apparatus and systems should not be construed in limiting in anyway. Instead, the present disclosure is directed toward all novel and nonobvious features and aspects of the various disclosed embodiments, alone in various combinations and sub combinations with one another. The disclosed methods, devices and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. I therefore claim as my invention all that comes within the spirit and scope of the claims.

We claim:

1. A method, implemented at least in part by one or more computing devices, for presenting a contract document for collaborative decision making, the method comprising:
displaying a contract document;
providing an interface adjacent the contract document for initiating a collaborative discussion activity;
receiving, within the interface, a designation of at least one clause of the contract for collaboration and at least one recipient to be invited to participate in the collaborative discussion activity;
receiving, within the interface, a call for a decision to be made relating to the at least one clause of the contract;
sending the call for the decision to the at least one recipient in a communication; and
updating a database to store at least the communication, an identity of a sender and the at least one recipient and any discussion or decision received in response to the communication.

2. The method of claim 1, further comprising receiving a decision comprising an approval of the at least one clause of the contract, and automatically updating the contract to include the at least one clause.

3. The method of claim 1, further comprising receiving a request to re-open decision making, and prompting at least one recipient for a decision.

4. The method of claim 1, further comprising sending the recipient a reminder communication if the recipient's response to the communication is not received within a desired time period.

5. The method of claim 2, wherein receiving a designation of at least one clause of the contract comprises specifying a clause with the displayed contract document by highlighting the clause and dragging the clause to a field of the interface adjacent to the contract document.

6. The method of claim 1, wherein the communication to the at least one recipient comprises voting buttons.

7. The method of claim 1, wherein the communication to the at least one recipient comprises pro and con tables.

8. The method of claim 1, further comprising displaying SWOT analyses for use in decision making.

9. The method of claim 1, further comprising presenting at least one polling question to the recipient.

10. The method of claim 1, wherein the at least one recipient comprises multiple recipients, further comprising receiving responses from the recipients and displaying a tally of the decisions in the responses.

11. One or more computer-readable storage media storing computer-executable instructions for causing a computing device to present a contract for collaborative decision making, the instructions comprising:
receiving a designation of at least one clause of a contract stored in memory;
receiving a designation of at least one recipient;
initiating a communication related to the at least one clause of the contract to the at least one recipient;
prompting the recipient for a decision related to the at least one clause of the contract;
receiving a response to the communication from the recipient, the response including a decision; and
storing the communication, response and decision.

12. A method of presenting on a display a user interface for collaborative decision making on a contract, the method comprising:
presenting the contract document such that a user can designate a clause of the contract document; and
in response to input from the user, initiating a separate discussion panel visible adjacent the contract document.

13. The method of claim 12, wherein the input from the user is actuating a discussion button or icon.

14. The method of claim 12, further comprising displaying a topic field in the separate discussion panel for the user to specify a topic.

15. The method of claim 12, further comprising displaying a content field within the separate discussion panel for the user to specify a contract clause for discussion with recipients.

16. The method of claim 12, further comprising displaying a recipients fields within the separate discussion panel for the user to specify one or more recipients of a communication initiating a collaborative decision making session about the contract clause.

17. The method of claim 12, further comprising receiving an input from a user to generate an activity and generating the activity, the activity being a separately trackable event.

18. The method of claim 17, wherein the activity is automatically updated with any decisions made by recipients.

19. The method of claim 17, wherein the activity is automatically updated and displayed with decision history.

20. The method of claim 17, wherein, following communication of decision and updating of the activity, further comprising presenting recipients with a control actuatable to re-open a decision.
